(19) United States
(12) Patent Application Publication
(10) Pub. No.: US 2016/0094757 A1
(43) Pub. Date: Mar. 31, 2016

(54) ELECTRONIC EQUIPMENT

(71) Applicant: KYOCERA Document Solutions Inc., Osaka (JP)

(72) Inventor: Keita Miyamoto, Osaka (JP)

(21) Appl. No.: 14/862,168

(22) Filed: Sep. 23, 2015

(30) Foreign Application Priority Data
Sep. 26, 2014 (JP) 2014-197557

(51) Int. Cl. H04N 1/44; H04N 1/32; H04N 1/00

(52) U.S. Cl. CPC H04N 1/444; H04N 1/00323; H04N 1/32037; H04N 2201/0094

(57) ABSTRACT

An electronic equipment includes a storage device and a transmission processing unit. The storage derive stores transmission prohibited component data designating, among components forming a screen, a component transmission of a component image of which is prohibited. The transmission processing unit transmits, when a change of screen image data is detected by a screen change detection unit, if a component in which the change of the screen image data is detected is not a component designated in transmission prohibited component data, image data of the component in which the change of the screen image data is detected to a predetermined monitoring apparatus, and does not transmit, if the component in which the change of the screen image data is detected is a component designated in transmission prohibited component data, the image data of the component in which the change of the screen image data is detected to the monitoring apparatus.

### INCORPORATION BY REFERENCE

The disclosure of Japanese Patent Application No. 2014-197557 filed on Sep. 26, 2014, including the specification, drawings and abstract is incorporated herein by reference in its entirety.

### BACKGROUND

This disclosure relates to an electronic equipment.

Remote support services are enabled for electronic equipments, such as a multifunction peripheral, and the like. In a system, a remote device is caused to display an image of a screen displayed on an operation panel of an electronic equipment, such as a multifunction peripheral, and the liked. In this case, for example, each time a change of image of a screen is detected, image data thereof is transferred to a remote device of a support service provider side via a network.

Techniques for keeping an image safe from being secretly looked at by a third person when the image is transmitted have been proposed.

### SUMMARY

According to an aspect of the present disclosure, an electronic equipment includes a display device, a display processing unit, a screen change detection unit, a storage device, and a transmission processing unit. The display device is configured to display a screen. The display processing unit is configured to cause the display device to display the screen on the basis of screen image data. The screen change detection unit is configured to detect a change of the screen image data. The storage device is configured to store transmission prohibited component data designating, among components forming the screen, a component transmission of a component image of which is prohibited. The transmission processing unit is configured to transmit, when a change of the screen image data is detected by the screen change detection unit, if a component in which the change of the screen image data is detected is not a component designated in the transmission prohibited component data, image data of the component in which the change of the screen image data is detected to a predetermined monitoring apparatus. The transmission processing unit is configured not to transmit, when a change of the screen image data is detected by the screen change detection unit, if the component in which the change of the screen image data is detected is a component designated in the transmission prohibited component data, the image data of the component in which the change of the screen image data is detected to the predetermined monitoring apparatus.

### BRIEF DESCRIPTION OF THE DRAWINGS

FIG. 1 is a block diagram illustrating a configuration of an image forming apparatus as an electronic equipment according to an embodiment of the present disclosure.

FIG. 2 is a view illustrating an example of a component in a screen displayed on the image forming apparatus illustrated in FIG. 1.

FIG. 3 is a flow chart illustrating an operation of the image forming apparatus illustrated in FIG. 1 in monitoring.

### DETAILED DESCRIPTION

Embodiments of the present disclosure will be described below with reference to the accompanying drawings.

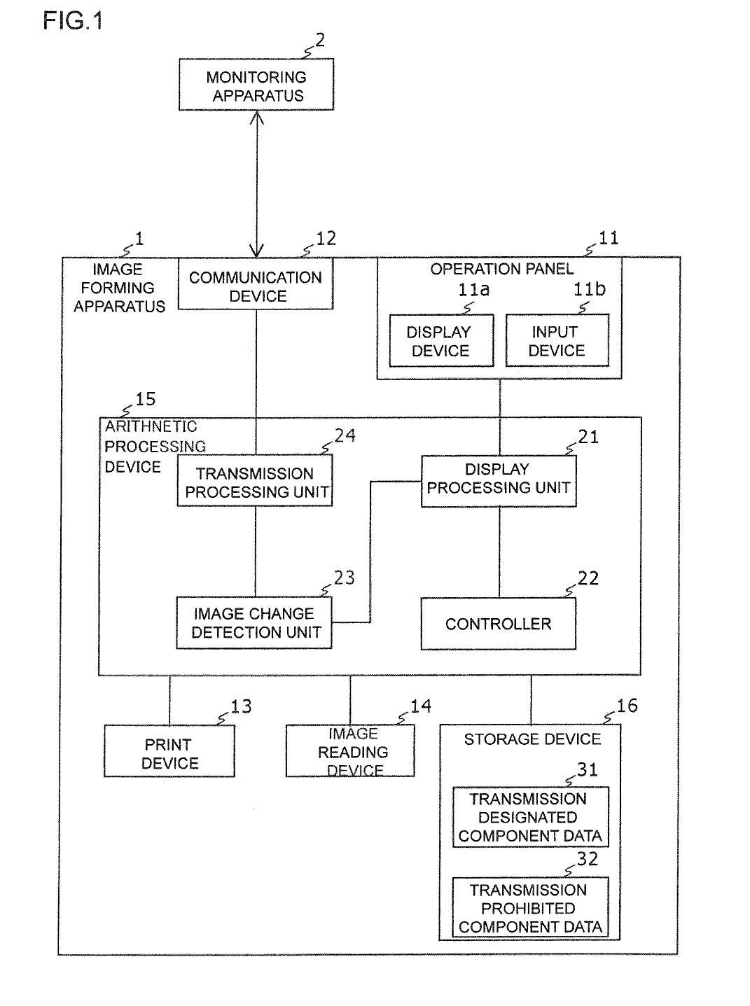

FIG. 1 is a block diagram illustrating a configuration of an image forming apparatus as an electronic equipment according to an embodiment of the present disclosure.

An image forming apparatus 1 in FIG. 1 is coupled to a remote monitoring apparatus 2 via a network or the like. In this embodiment, the image forming apparatus 1, which is an example of an electronic equipment, is a multifunction peripheral. However, the image forming apparatus 1 may be some other apparatus, such as a printer, a facsimile apparatus, a copy machine, and the like, which has a print function. The remote monitoring apparatus 2 receives image data of an image change part of a screen of a display device 11a of the image forming apparatus 1 or image data of the entire screen, and displays an image indicating a screen of the image forming apparatus 1 on the basis of the image data.

As illustrated in FIG. 1, the image forming apparatus 1 includes an operation panel 11, a communication device 12, a print device 13, an image reading device 14, an arithmetic processing device 15, and a storage device 16.

The operation panel 11 includes the display device 11 a, such as a liquid crystal display and the like, which displays a screen, such as an operation screen and the like, and an input device 11b, such as a touch panel and the like, displays the operation screen to a user, and detects a user operation.

The communication device 12 is a device which is connectable to the monitoring apparatus 2 via a network or the like, and performs data communication using a predetermined communication protocol.

The print device 13 is an internal device that prints an original image on a print paper, for example, using an electrographic method. The print device 13 performs predetermined image processing, such as rasterization, color conversion, screen processing, and the like, on original image data, and thus, performs printing on the basis of output image data generated by the predetermined image processing.

The image reading device 14 is an internal device that optically reads an original image from an original document and generates image data of the original image.

The arithmetic processing device 15 is a computer including a central processing unit (CPU), a read only memory (ROM), a random access memory (RAM), and the like, loads a program stored in the ROM or the storage device 16 to the RAM, causes the CPU to execute the program, and thereby realizes various processing units.

The storage device 16 is a nonvolatile storage device, such as a flash memory and the like, and stores various types of data and programs.

In the arithmetic processing device 15, a display processing unit 21, a controller 22, a screen change detection unit 23, and a transmission processing unit 24 are realized.

The display processing unit 21 draws screen image data in a video memory area (not illustrated) and causes the display device 11a to display a screen on the basis of the screen image data stored in the video memory area.

The controller 22 controls the internal devices, such as the print device 13 and the like, executes various jobs, and gives an order to draw screen image data to the display processing unit 21 in accordance with the user operation, the state of the image forming apparatus 1, the state of a job, and the like.

The screen change detection unit 23 monitors screen image data in the video memory area and detects a change of the screen image data. In this case, the screen change detection unit 23 monitors the value of each pixel of a screen image and determines, when the value of at least one pixel changes, that the screen image data has changed.

The transmission processing unit 24 has a function of transmitting, if the screen change detection unit 23 detects a change of the screen image data, image data for a component of a part of a screen in which the screen image data has changed to the monitoring apparatus 2 using the communication device 12.

Transmission designated component data 31 and transmission prohibited component data 32 are stored in the storage device 16.

The transmission designated component data 31 designates, when a change of screen image data is detected in a component, among components forming a screen displayed by the operation panel 11, a component a component image of which is transmitted

The transmission prohibited component data 32 designates, among the components (such as a soft key, an input field, a display text, a display image, and the like) forming a screen displayed by the operation panel 11, transmission of a component image of which is prohibited.

Note that a unique tag (identifier) is allocated to each component in a screen, and the component is designated by the tag in the transmission designated component data 31 and the transmission prohibited component data 32.

In this embodiment, the transmission prohibited component data 32 designates a component selected by the user operation. That is, the component designated by the user operation performed on the input device 1 lb is registered in the transmission prohibited component data 32. For example, a tag is input by the user operation, and the input tag is added to the transmission prohibited component data 32.

On the basis of the transmission prohibited component data 32, if, when a change of screen image data is detected by the screen change detection unit 23, a component in which the change of screen image data is detected is not a component designated by the transmission prohibited component data 32, the transmission processing unit 24 transmits image data of the component in which the change of screen image data is detected to the monitoring apparatus 2 and, if the component in which the change of screen image data is detected is a component designated by the transmission prohibited component data 32, the transmission processing unit 24 does not transmit the image data of the component in which the change of screen image data is detected to the monitoring apparatus 2.

The display processing unit 21 displays each component on the basis of component data, such as a type, a display position, a display size, and the like, of the component, associated with a tag. Note that the component data is stored, for example, in the storage device 16. Thus, on the basis of the component data, first, the screen change detection unit 23 specifies the tag of a component in which the screen image data has changed, from the position in which the screen image data has changed. Then, the transmission processing unit 24 determines whether or not the specified tag matches any one of tags in the transmission prohibited component data 32 and, if the specified tag matches one of the tags in the transmission prohibited component data 32, the transmission processing unit 24 does not transmit image data (raster image data) of the component after the change to the monitoring apparatus 2.

If a change of the screen image data is detected in a component designated in the transmission prohibited component data 32, the transmission processing unit 24 transmits, instead of the image data of a component designed, a report indicating that the change of the screen image data is detected in the component designed to the monitoring apparatus 2. For example, in the report, the component in which the change of the screen image data is detected is indicated by a tag. Thus, the component of a part in which there is a screen change may be specified at a service provider side.

Furthermore, in this embodiment, when a change of the screen image data is detected by the screen change detection unit 23 on the basis of the transmission designated component data 31 and then the component in which the change of the screen image data is detected is not a component designated in the transmission prohibited component data 32, (a) if the component in which a change of the screen image data is detected is a component designated in the transmission designated component data 31, the transmission processing unit 24 transmits image data of the component in which a change of the screen image data is detected to the monitoring apparatus 2 and, (b) if the component in which the change of the screen image data is detected is not a component designated in the transmission designated component data 31, the transmission processing unit 24 does not transmit image data of the component in which the change of the screen image data is detected to the monitoring apparatus 2.

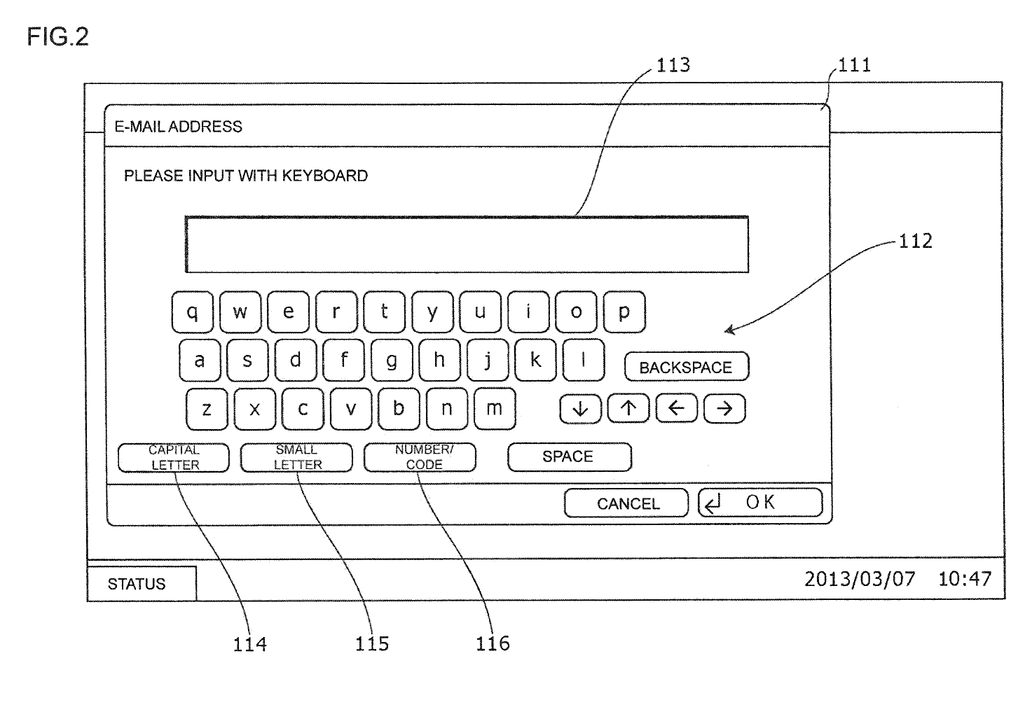

FIG. 2 is a view illustrating an example of a component in a screen displayed on the image forming apparatus 1 illustrated in FIG. 1. For example, in a screen illustrated in FIG. 2, a dialogue 111 used for inputting an e-mail address, which is a transmission destination of an original image, is displayed, and the dialogue 111 includes a software keyboard 112 used for inputting an e-mail address, an input field 113 in which the input e-mail address is displayed, and switching keys 114 to 116 used for switching key display of the software keyboard 112. The switching key 114 is used for switching key display to a capital letter key mode, the switching key 115 is used for switching key display to a small letter key mode, and the switching key 116 is used for switching key display to a number/code key mode.

Each of the dialogue 111, the software keyboard 112, the input field 113, and each of the switching keys 114 to 116 may be designated as a component.

For example, the input field 113 in which an e-mail address, which is individual information, is displayed is registered in the transmission prohibited component data 32. For example, when the input field 113 is registered in the transmission prohibited component data 32, image data of the input field 113 is not transmitted to the monitoring apparatus 2, for example, at the time when the e-mail address is input in the input field 113 by a user and the e-mail address is displayed in the input field 113, although the input field 113 is registered in the transmission designated component data 31.

For example, in a case where the software keyboard 112 is not registered in the transmission designated component data 31, whether or not the software keyboard 112 is registered in the transmission prohibited component data 32, image data of the software keyboard 112 is not transmitted to the monitoring apparatus 2 even when key display of the software keyboard 112 is changed using the switching keys 114 to 116.

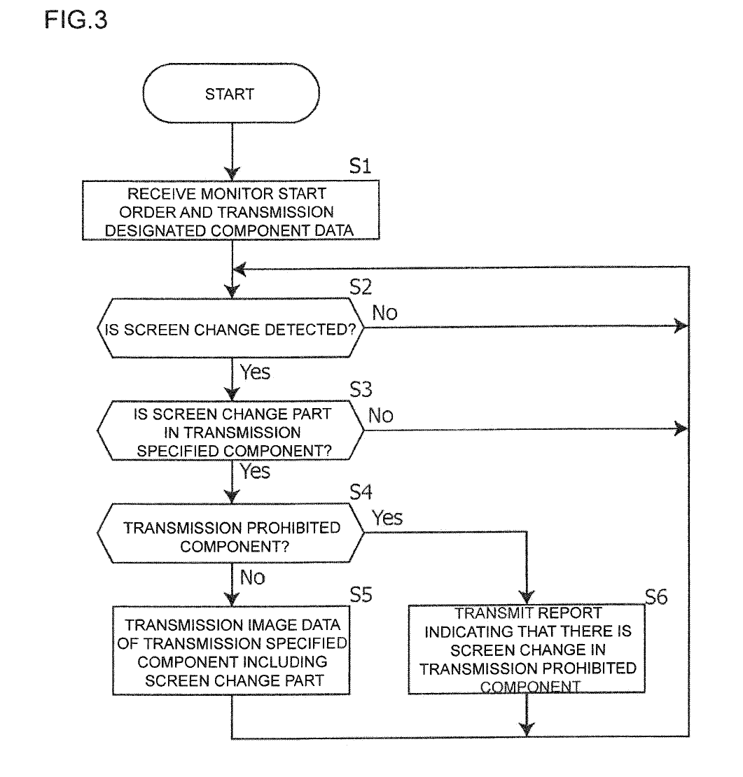

Next, an operation of the image forming apparatus 1 will be described. FIG. 3 is a flow chart illustrating an operation of the image forming apparatus 1 illustrated in FIG. 1 in monitoring.

First, when an operator at the support service provider side operates the monitoring apparatus 2, designates the image forming apparatus 1, which is a monitor target, and performs an operation of a start of monitoring, the monitoring apparatus 2 transmits a monitor start order and transmission designated component data to the image forming apparatus 1, which is a monitor target. Note that the transmission designated component data may be prepared in advance for each model of the image forming apparatus 1 and the operator may operate the monitoring apparatus 2 to input the transmission designated component data.

In the image forming apparatus 1, the transmission processing unit 24 receives the monitor start order and the transmission designated component data from the monitoring apparatus 2 using the communication device 12 (Step S1).

When the monitor start order and the transmission designated component data are received from the monitoring apparatus 2, the screen change detection unit 23 starts monitoring screen image data (that is, detection of a change of the screen image data).

The screen change detection unit 23 monitors screen image data in a predetermined video memory area (Step S2) and, when a change of the screen image data is detected, the screen change detection unit 23 specifies a component in which the change of the screen image data occurred and reports the specified component to the transmission processing unit 24.

When the transmission processing unit 24 receives the report, the transmission processing unit 24 first determines whether or not the component is a component designated in the transmission designated component data 31 (Step S3).

If the component is not a component designated in the transmission designated component data 31, the transmission processing unit 24 does not transmit image data of the component after the change to the monitoring apparatus 2.

On the other hand, if the component is a component designated in the transmission designated component data 31, the transmission processing unit 24 determines whether or not the component is a component designated in the transmission prohibited component data 32 (Step S4).

If the component is a component designated in the transmission designated component data 31 and is not a component designated in the transmission prohibited component data 32, the transmission processing unit 24 transmits the image data of the component after the change to the monitoring apparatus 2 (Step S5).

On the other hand, if, although the component is a component designated in the transmission designated component data 31, the component is a component designated in the transmission prohibited component data 32, the transmission processing unit 24 does not transmit the image data of the component after the change to the monitoring apparatus 2 and, instead, transmits a report indicating that there is an image change in the component to the monitoring apparatus 2 (Step S6).

When the image forming apparatus 1 transmits image data of the component in which there is an image change, the monitoring apparatus 2 receives the image data of the component, combines a component image based on the received image data with an image of a screen including the component, and displays the acquired combined image of the screen to the operator.

Note that, when image data of the component is transmitted, a tag of the component is transmitted in association with the image data of the component, the monitoring apparatus 2 has similar component data to the above-described component data, receives the tag of the component with the image data of the component, specifies a screen including the component and the position and size of the component in the screen from the tag on the basis of the component data, and combines a component image thereof with an image of the screen. Also, image data of each screen may be acquired from the image forming apparatus 1 by the monitoring apparatus 2, and may be stored in the monitoring apparatus 2 in advance.

On the other hand, if the image forming apparatus 1 transmits a report of the component in which there is an image change, the monitoring apparatus 2 highlights a part of the component of the report in the image of the screen by performing highlight display, blink display, or the like.

Thereafter, the image forming apparatus 1 continuously executes the above-described processing of Steps S2 to S6 until the image forming apparatus 1 receives a monitor end order from the monitoring apparatus 2. Note that the monitor end order is transmitted from the monitoring apparatus 2 on the basis of an operation of the operator.

As described above, according to the above-described embodiment, the display processing unit 21 causes the display device 11a to display a screen on the basis of screen image data. If, when a change of the screen image data is detected by the screen change detection unit 23, a component in which the change of the screen image data is detected is not a component designated in the transmission prohibited component data 32, the transmission processing unit 24 transmits image data of the component in which the change of the screen image data is detected to the monitoring apparatus 2 and, if the component in which the change of the screen image data is detected is a component designated in the transmission prohibited component data 32, the transmission processing unit 24 does not transmit the image data of the component in which the change of the screen image data is detected to the monitoring apparatus 2.

Thus, when an image of an operation panel is transmitted to a support service provider side in order to provide a support service, it may be prohibited to provide specific information, such as individual information and the like, displayed on the operation panel to the support service provider.

Note that the above-described embodiment is a preferred example of the present disclosure, but the present disclosure is not limited thereto, and various alterations or modifications may be made in a range not departing from the gist of the present disclosure.

For example, in the above-described embodiment, as an example, the input field 113 of an e-mail address is registered in the transmission prohibited component data 32, and furthermore, a component in which individual information, such as a user name, a user's address, a user's telephone number, and the like, is displayed may be registered in the transmission prohibited component data 32.

The present disclosure is applicable, for example, to an image forming apparatus.

What is claimed is:

1. An electronic equipment comprising:
a display device configured to display a screen;
a display processing unit configured to cause the display device to display the screen on the basis of screen image data;
a screen change detection unit configured to detect a change of the screen image data;
a storage device configured to store transmission prohibited component data designating, among components forming the screen, a component transmission of a component image of which is prohibited; and
a transmission processing unit configured to transmit, when a change of the screen image data is detected by the screen change detection unit, if a component in which the change of the screen image data is detected is not a component designated in the transmission prohibited component data, image data of the component in which the change of the screen image data is detected to a predetermined monitoring apparatus, and not to transmit, if the component in which the change of the screen image data is detected is a component designated in the transmission prohibited component data, the image data of the component in which the change of the screen image data is detected to the predetermined monitoring apparatus.

2. The electronic equipment according to claim 1,
wherein, if the change of the screen image data is detected in a component designated in the transmission prohibited component data, the transmission processing unit transmits, instead of the image data of the component designed, a report indicating that the change of the screen image data is detected in the component designed to the predetermined monitoring apparatus.

3. The electronic equipment according to claim 1,
wherein, when the change of the screen image data is detected by the screen change detection unit, on the basis of the transmission designated component data designating, when the change of the screen image data is detected, among components forming the screen, a component a component image of which is to be transmitted, and then, the component in which the change of the screen image data is detected is not a component designated in the transmission prohibited component data, (a) if the component in which the change of the screen image data is detected is a component designated in the transmission designated component data, the transmission processing unit transmits image data of the component in which the change of the screen image data is detected to the predetermined monitoring apparatus and, (b) if the component in which the change of the screen image data is detected is not a component designated in the transmission designated component data, the transmission processing unit does not transmit the image data of the component in which the change of the screen image data is detected to the monitoring apparatus.

4. The electronic equipment according to claim 3, wherein
the transmission processing unit receives the transmission designated component data from the monitoring apparatus, and
after the transmission designated component data is received from the monitoring apparatus, the screen change detection unit starts detection of a change of the screen image data.

5. The electronic equipment according to claim 1, further comprising:
an input device configured to receive a user operation,
wherein
the transmission prohibited component data designates a component selected by the user operation performed on the input device.
